(19) United States
(12) Patent Application Publication
(10) Pub. No.: US 2010/0062172 A1
(43) Pub. Date: Mar. 11, 2010

(54) METHOD FOR THE PRODUCTION OF AN ABRADABLE SPRAY COATING

(75) Inventors: Andreas Jakimov, Muenchen (DE); Manuel Hertter, Muenchen (DE); Andreas Kaehny, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/529,335

(22) PCT Filed: Feb. 25, 2008
(86) PCT No.: PCT/DE08/00333

§ 371 Date: Aug. 31, 2009

(30) Foreign Application Priority Data
Mar. 1, 2007 (DE) 10 2007 010 049.5

(51) Int. Cl. B05D 1/08; B05C 21/00

(52) U.S. Cl. 427/446; 118/665

(57) ABSTRACT

A method for producing a spray coating, in particular an abradable spray coating for components of a turbine engine by a thermal spraying process, is disclosed. An online process monitoring system, especially a PFI unit and/or a spectrometer unit, is provided for monitoring and regulating the thermal spraying process, where at least one process parameter is calculated according to the formula p_{B1}=P_{B2}+H_{B1}−H_{B2}−(Δx·y)/z+n, where p_{B1} is the process parameter of the component that is to be coated, p_{B2} is the process parameter of a previous coating, H_{B1} is the hardness of the spray coating that is to be coated, H_{B2} is the hardness of the previous spray coating, Δx is a process variable of the online process monitoring system, and y, z and n are constant parameters.

### BACKGROUND AND SUMMARY OF THE INVENTION

This application claims the priority of International Application No. PCT/DE2008/000333, filed Feb. 25, 2008, and German Patent Document No. 10 2007 010 049.5, filed Mar. 1, 2007, the disclosures of which are expressly incorporated by reference herein.

The invention relates to a method for producing a spray coating, in particular an abradable spray coating for components of a turbine engine. Furthermore, the invention relates to a device for carrying out this method.

In order to increase the degree of efficiency of turbine engines, in particular for aviation, current compressor development is aimed at increasing pressure ratios. Furthermore, the requirement for a lighter structure, which is possible, for example, by reducing the number of stages, produces an increase in the pressure ratio between the compressor stages. A side effect of this development is an increase in the backflow from the pressure side to the suction side of the compressor blades.

As a result, the significance of the sealing system, which prevents the backflow described above between the rotating compressor blades and the compressor housing, has become ever more important. This sealing system is an important element of the degree of efficiency and has a substantial impact on the so-called pump line and therefore on the stable operation of the engine.

In order to prevent a high backflow rate, it is necessary to reduce the gap between the rotating compressor blades and the compressor housing as much as possible. Because of the different operating states during operation of an engine such as, for example, acceleration, idling, stationary operation, etc., the tips of the rotating rotor blades can touch the inside wall of the compressor housing or even experience running-in. Furthermore, running-in may also occur due to an eccentricity of the rotor or housing, which can be caused by flight maneuvers for example.

In order to prevent greater damage in the case of a running-in of the rotating rotor blades in the compressor housing, potential contact surfaces of the housing are provided abradable coatings, so-called running-in coatings.

So that the blades can work into the corresponding locations on the compressor housing, it must be relatively easy to abrade the coating material without damaging the tips of the blades. Moreover, the coating must also possess good resistance to particle erosion and other degradation at elevated temperatures.

For this type of coating, U.S. Pat. No. 5,434,210 discloses a thermal spray powder and a composite coating made of this powder, which has a matrix component, a dry lubricant component and a synthetic component. A corresponding powder for thermal spraying can be procured from Sulzer Metco Co. under the designation SM2042.

Thermal spraying designates a method for producing a spray coating on a surface of a substrate, wherein filler materials are directed onto the to-be-coated surface of a substrate with the use of a gas. German Patent Document No. DE 102004041671 A1 describes this type of method and a monitoring system for quality assurance of the sprayed layers. It is a so-called PFI (particle flux imaging) method in this case.

In the case of the PFI system described in DE 102004041671 A1, a cluster of the particles that influence the quality of the spray layer is recorded with a digital camera. This image is then depicted or further processed by arithmetic analysis.

This makes diagnostics of a thermal spraying process possible.

Furthermore, European Patent Document No. EP 1 332 799 A1 describes a device and a method for thermal spraying, in which a partly fused or molten filler material is directed onto the to-be-coated surface of a substrate with the use of a gas or gas mixture. In doing so, at least one characteristic of the thermal spraying process that influences the quality of the spray layer, which is responsible for the development of the layer and its properties, is recorded, analyzed and regulated by means of an optical spectroscopy arrangement. As a result, a possibility for the online regulation and optimization of one or more parameters that are responsible for the development of the spray coating is provided.

Despite the method for the quality assurance of thermal spraying processes described above, it has not been possible up to now to reproducibly produce an abradable spray coating having a low hardness, in particular from the SM2042 powder, but also from other materials for components. This is due above all to the very unstable spraying process. In particular, it is currently not possible to produce a coating to specifications when there are process deviations. Currently, the hardness of the coating can only be measured in a burned-off state, whereby approximately one day is lost before the spraying process can be continued. In the process, the spraying conditions may change during the waiting period. However, if this procedure is omitted, it results in very high rates of post-processing of the coated components.

The objective of the invention is therefore to avoid the technical problems of the prior art described in the foregoing and to provide an improved method for producing an abradable spray coating, which makes it possible to monitor the spraying process using defined parameters. Furthermore, a device for carrying out the method is made available.

### DETAILED DESCRIPTION OF INVENTION

The invention avoids the technical problems of the prior art and provides an improved method and an improved device for producing an abradable spray coating in a reliable process.

The inventive method for producing a spray coating, in particular an abradable spray coating for components of a turbine engine by means of a thermal spraying process, wherein an online process monitoring system, especially a PFI unit and/or a spectrometer unit, is provided for monitoring and regulating the thermal spraying process, is characterized in that at least one process parameter is calculated according to the formula:

p_{B1}=p_{B2}+H_{B1}−H_{B2}−(Δx·y)/z+n;

wherein p_{B1} is the process parameter of the coating that is to be currently applied, p_{B2} is the corresponding process parameter of a previous coating, i.e., of a previous component or of one of the previous samples, H_{B1} is the hardness of the spray coating that is to be currently applied, H_{B2} is the hardness of the previously applied spray coating, Δx is a process variable of the online process monitoring system, and y, z and n are constant parameters. It is hereby possible, based on previously coated components and the properties of these layers, for abradable spray coatings to be produced in a reliable process without great delay and the associated changes to basic conditions.

An advantageous further development of the method provides for the coating to be carried out with SM2042 powder. This powder is especially suited for applications with axial turbo-machines.

Another advantageous further development of the method provides for the calculation to be carried out after adjusting the desired process parameter online or as an alternative to this before or after each coating. As a result, the process parameter(s) can then be adjusted automatically, e.g., using actuators, or manually under constant monitoring.

Another advantageous further development of the method provides for the spray coating to be applied to a compressor housing. Because of the method, a running-in coating can now be reproducibly produced with a low hardness.

The constant parameters y and z that are relevant for the respective process parameter of a coating are expressed by the correlation between the process variable of the online process monitoring system and of the respective process parameter. This lies advantageously between 0 and 15, wherein the interval limits are included. y is preferably between 2 and 5, in particular preferably 3, while z is preferably between 8 and 12 and in particular preferably 10.

The constant parameter n that is relevant for each process parameter in the respective coating takes a component change into consideration, i.e., a transfer from a spray layer of one component to another component, and lies in particular between −10 and +10, in particular between −5 and +5, wherein the interval limits are included in each case.

In particular the primary gas rate, secondary gas rate, but also the distance between the component and burner are possible as the to-be-monitored process parameters. In addition, other process parameters not cited here may absolutely be regulated by the inventive method and namely in such a way that a reproducible result of the spray layer is yielded.

In terms of the measured process variable of the online process monitoring system Δx, it is possible to allow a currently measured process variable to be incorporated into the coating process.

However, it is preferred that a change in the process variable be used, which is embodied such that the corresponding process variable of the current coating is related to the respective process variable of the previous coating of the last component.

In doing so, the process variable Δx can be determined from the luminance distribution of the plasma and/or particle beam, which is recorded in particular by the PFI unit or the spectrometer unit.

The determination of the semiaxes of the ellipses from the measurement of the PFI unit is offered to establish the process variable Δx from the luminance distribution.

An inventive device for carrying out the inventive method features for online process monitoring, on the one hand, a PFI monitoring system and/or an optical emission spectroscopy unit, whose process monitoring characteristics are correlated in an arithmetic unit, whereby a reproducible spray coating can be produced in the case of process of deviations. Furthermore, actuators can be provided here to automatically adjust the process parameters.

Additional measures improving the invention are presented in greater detail in the following along with the description of a preferred exemplary embodiment of the invention.

The use of process monitoring serves to avoid post-processing as well as quality monitoring and documentation of the spraying process. With this method, the properties of the plasma and the particles in the plasma beam are recorded and correlated with the layer properties. If the measured properties deviate from a reference standard defined in advance, corrective action must be taken to prevent post-processing.

To this end, the multifunction process monitoring system is equipped with an Online Particle Flux Imaging (PFI) System, an optical spectrometer and a radiation pyrometer. The PFI system is used to check the plasma beam before and after coating the component. The spectrometer also makes quality monitoring possible during the spraying process.

With the aid of a CCD camera, the PFI records the luminance distributions of the plasma and particle beam that are characteristic for the coating process. An algorithm is used to calculate the contour lines with the same luminous intensity from the recordings. An ellipse for the plasma and particle beam is inscribed in each of these contour lines. The ellipse characteristics such as semiaxes a and b, the center of gravity of the ellipse and the angle of the semiaxis a with respect to the horizontal are used to describe the current spraying status.

The hardness of the layer to be applied (measured in HR 15 Y) can now be regulated or monitored by a process parameter and a process variable. To this end, the hardness of the previously produced layer and the process parameter(s) or the process variable as well as the constant parameters are incorporated into the regulation or calculation. In selecting the distance between the component and burner, good results have been obtained for y=3 and z=10 as process parameters, in particular when information from the values measured using the PFI unit, particularly the luminance distribution of the plasma and/or particle beam from the current coating process and a previous coating process, are used as process variable Δx. The change in the semiaxes of the measured ellipses from the current process and a previous process are used in particular in this case. However, it is also possible to use the center of gravity of the ellipses or the angle of the semiaxes.

The optical spectrometer uses a measuring head to record the light emitted when spraying plasma and the particles, and conveys it via a fiber-optic cable to a highly sensitive spectrograph. Chronological tracking of the entire spectral emission as well as several characteristic measuring lines of the overall spectrum make it possible to detect and save changes in intensity.

Moreover, the radiation pyrometer is used for contactless temperature measurement during the coating process. It guarantees the recording and graphic output of the measuring data from the entire coating process.

The measuring structure and the adjustment of the PFI and the optical spectrometer are not meant to be addressed in detail here.

In terms of its design, the present invention is not restricted to the preferred exemplary embodiment disclosed in the foregoing. In fact, a number of variations are conceivable, which make use of the described solution even in the case of fundamentally different designs.

1-12. (canceled)

13. A method for producing an abradable spray coating for a component of a turbine engine by a thermal spraying process, comprising the steps of:
monitoring and regulating the thermal spraying process by an online process monitoring system, wherein at least one process parameter is calculated according to the formula:
p_{B1}=p_{B2}+H_{B1}−H_{B2}−(Δx·y)/z+n;
wherein p_{B1} is a process parameter of the component that is to be coated, p_{B2} is a process parameter of a previous spray coating, H_{B1} is a hardness of the spray coating that is to be applied, H_{B2} is a hardness of the previous spray coating, Δx is a process variable of the online process monitoring system, and y, z and n are constant parameters.

14. The method according to claim 13, wherein the online process monitoring system is a PFI unit and/or a spectrometer unit.

15. The method according to claim 13, wherein the spray coating is carried out with SM2042 powder.

16. The method according to claim 13, wherein the calculation for adjusting the process parameter is carried out online.

17. The method according to claim 13, wherein the calculation for adjusting the process parameter is carried out before and after coating.

18. The method according to claim 13, wherein the spray coating is applied to a compressor housing.

19. The method according to claim 13, wherein the parameters y and z lie between 0 and 15.

20. The method according to claim 18, wherein the parameter n takes a component change into consideration and lies between −10 and +10.

21. The method according to claim 13, wherein the process parameter is a primary gas rate, a secondary gas rate, or a distance between a component and a burner.

22. The method according to claim 13, wherein the process variable Δx is determined from a relation of the previous spray coating and the spray coating that is to be applied.

23. The method according to claim 13, wherein the process variable Δx is determined from a luminance distribution of a plasma and/or a particle beam.

24. The method according to claim 23, wherein the luminance distribution is established by determining semiaxes of the ellipses.

25. A device for carrying out the method according to claim 13, wherein the monitoring is performed by a PFI monitoring system and/or an optical emission spectroscopy unit, whose process monitoring characteristics are correlated in an arithmetic unit, whereby a reproducible spray coating is producible in process with process deviations.
